(19) United States
(12) Patent Application Publication
(10) Pub. No.: US 2026/0268587 A1
(43) Pub. Date: Sep. 10, 2026

(54) GENERATING VIDEO DATA FOR SIMULATING HUMAN PERCEPTION

(71) Applicant: Axon Enterprise, Inc., Scottsdale, AZ (US)

(72) Inventor: Juha Alakarhu, Tampere (FI)

(21) Appl. No.: 18/875,600

(22) PCT Filed: Jun. 16, 2023
(86) PCT No.: PCT/US23/25611

§ 371 Date: Dec. 16, 2024

Related U.S. Application Data
(60) Provisional application No. 63/352,739, filed on Jun. 16, 2022.

(51) Int. Cl. G06T 15/20; G06F 3/01; G06T 5/50; G06T 5/70

(52) U.S. Cl. CPC G06T 15/205; G06F 3/012; G06F 3/013; G06T 5/50; G06T 5/70; G06T 2207/10016; G06T 2207/10144; G06T 2207/20212

(57) ABSTRACT

A recording system comprises one or more cameras and a computing device. The one or more cameras are worn by a user at an incident and are configured to capture respective video data and to transmit the video data to the computing device. The computing device combines the video data to provide simulated video data representing the perception of the user at the incident. The simulated video data may accurately represent one or more of head orientation of the user, gaze of the user, lighting adaptation of an eye of the user, blur and/or stabilization representative of perception of the user.

### FIELD OF INVENTION

Embodiments of the present invention relate to camera systems for simulating human vision.

### BACKGROUND

Personnel such as law enforcement officers, first responders, firefighters, and recreationalists use cameras to capture events, so that a video and/or audio record exists regarding what happened in an incident. These cameras may be mounted on vehicles such as cars and drones, and they may also be worn on the body as body-worn cameras. Numerous mounting systems exist to mount cameras to personnel. These systems include a variety of coupling methods including those that enable a body-worn camera to be mounted to a torso or head of a person.

However, video data captured by mounted cameras may not accurately represent perception of personnel during incidents. For example, cameras may use lighting algorithms that adapt more quickly or more slowly than the human eye to changes in light, may capture video data having a different field of view than a human, or may not accurately represent the direction in which personnel was looking during incidents. In another example, cameras mounted in a fixed position, such as on a vehicle, may not capture all information that is within the visual perspective of the personnel. Because personnel make decisions and take actions during incidents based on their perception of information during the incident, video data that misrepresents the amount or kind of information available to personnel during incidents may cause discrepancies upon later review of the video. In order to gauge whether correct actions were taken by personnel, it may be beneficial to have video data that accurately represents the perception of personnel during incidents.

### BRIEF DESCRIPTION OF THE DRAWINGS

FIG. 1 shows an environment including one or more cameras and a computing device, according to some embodiments.

FIG. 2A shows an example architecture for a recording device, according to some embodiments.

FIG. 2B shows an example architecture for a computing device, according to some embodiments.

FIGS. 3A-3C are example illustration of video data captured by the one or more cameras and processed to generate simulated video data, according to some embodiments.

FIG. 4 is a flowchart illustrating a method for capturing video data for generating simulated video data, according to some embodiments.

FIG. 5 is a flowchart illustrating a method for processing video data to generate simulated video data, according to some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The detailed description of exemplary embodiments herein refers to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Additionally, any reference to without contact (or similar phrases) may also include reduced contact or minimal contact.

Systems, methods, and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

In various embodiments, an incident (or similar terms and phrases, such as an emergency or event) refers to human or animal activities and to a period of time while these activities take place. Incidents include, for example, formation of agreements, transactions, negotiations, discussions, ceremonies, meetings, medical procedures, sporting events, crimes, attempted crimes, disagreements, assaults, conflicts, discoveries, research, investigations, surveillance, and/or the like. Incidents may include consequences including changes to property such as improvements, repairs, construction, production, manufacture, growth, harvesting, damage, loss, theft, burglary, arson, goods damaged in shipment, conditions of real estate, and/or conditions of agricultural and forestry property. An incident may include damage to property and/or injury to persons or animals. Damage to property or injury to persons or animals may be accidental or brought on by the action or failure to act of one or more persons. Incidents include information that may be valuable or otherwise important, helpful, or needed for risk management, insurance, claims, achievements, sports records, news reporting, entertainment, and/or the like.

One or more incident responders may respond or help before, during, or after an incident. For example, in response to an incident including a fire (e.g., burning building, house fire, etc.), incident responders may typically include a law enforcement officer, a firefighter, and/or a medical responder (e.g., an emergency medical technician (EMT), a paramedic, an ambulance technician, etc.). As a further example, in response to an incident including a crime or attempted crime, incident responders may include one or more law enforcement officers.

Information (e.g., data, audio, visual, location, environmental, etc.) gathered about an incident may describe the incident. Information may include facts about the activities of the incident, consequences of the incident, time of the incident, location of the incident, and identity of humans, animals, or objects related to the incident. Information about an incident may form a report of an incident (e.g., an incident report). Information about the incident may be gathered before, during, or after an incident. Incident information may be recorded (e.g., audio, video) to document an incident at the time of occurrence.

Recording incident information captures at least some of the information about the incident. Recording further protects against loss of information, for example, by physical loss or by faulty human memory. For example, incident responders may capture audio and/or visual information of the incident. The audio and/or visual information may be captured by an incident recording device, such as, for example, a body-worn camera, a smart phone or internet of things (IoT) device, a vehicle-mounted camera, a surveillance camera, and/or any other recording device discussed herein. The recording device may be physically located at a scene of the incident to capture the information about the incident.

An incident recording device may capture incident information from a fixed position (e.g., a fixed field of view, a fixed vantage point, etc.). A fixed position may comprise a position that does not follow or align with a field of view or perception of an incident responder during the incident. The fixed position may be defined relative to an object to which the recording device is attached. For example, a body-worn camera may capture a fixed position from the body of the incident responder, a vehicle-mounted camera may capture a fixed position from the vehicle, etc. The fixed position may include information that is not within the visual perspective (e.g., visual point of view) of the incident responder. The fixed position may not capture all information that is within the visual perspective of the incident responder. For example, the responder may turn their head, resulting in a misalignment between a direction (e.g., forward direction) of a fixed field of view of a chest-mounted body worn camera and the direction (e.g., lateral or vertical direction) of the visual point of view of the responder.

In the following description and throughout the disclosure, the terms “recording device” and “camera” may be used interchangeably. It will be apparent to one skilled in the art that each of these terms refers to a device capable of capturing one or more of video, audio, and/or image data and transmitting the video, audio, and/or image data via a communications network.

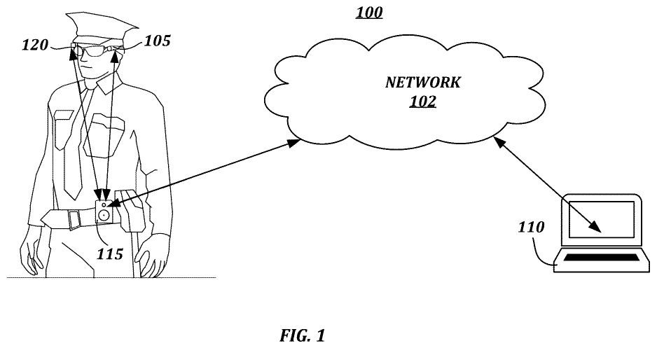

In various embodiments, and with reference to FIG. 1, a recording system 100 is disclosed. The recording system 100 may be configured to selectively capture incident information from a plurality of vantage points. For example, the recording system 100 may be configured to capture incident information from one or more fields of view. At least a portion of recording system 100 may capture a visual point of view at least partially aligned with a point of view of the incident responder. In various embodiments, and as discussed further herein, the recording system 100 may be configured to provide a plurality of interconnected recording devices, each recording device configured to capture incident information at a different vantage point. In various embodiments, and as discussed further herein, the recording system 100 may comprise a single recording device comprising detachable components configured to capture incident information at different vantage points.

In various embodiments, a recording system 100 may comprise one or more recording devices 105, 115, 120, each recording device of the one or more recording devices having a respective housing. For example, a first housing may include a first recording device 115 (e.g., an auxiliary recording device), and a second housing may include a second recording device 105 (e.g., a primary recording device). The first recording device 115 may capture incident information independent of the second recording device 105. The second recording device 105 may capture incident information independent of the first recording device 115. The first recording device 115 and the second recording device 105 may cooperate to capture incident information. The second recording device 105 may instruct the first recording device 115 to capture incident information.

Recording devices of recording system 100 may capture separate video data. For example, the first recording device 115 may capture first video data and the second recording device 105 may capture second video data. The first video data may contain first captured data and the second video data may contain second captured data. Captured data may comprise metadata such as location data, timestamps, and the like associated with the respective video data. The first captured data may be at least partially the same as the second captured data (e.g., the first video data and the second video data may each capture the same incident information from different points of view). The first captured data may be at least partially different than the second captured data (e.g., the first video data may capture incident information that the second video data did not capture, the second video data may capture incident information that the first video data did not capture, etc.).

In various embodiments, the recording system 100 may additionally comprise a third housing comprising a third recording device 120. The third recording device 120 may capture incident information independent of one or more of the first recording device 115 and the second recording device 105. The third recording device 120 may cooperate with one or more of the first recording device 115 and the second recording device 105 to capture incident information. The third recording device 105 may capture third video data containing third captured data. The third captured data may be at least partially the same as one or more of the first captured data or the second captured data. The third captured data may be at least partially different than one or more of the first captured data and the second captured data. In some embodiments, the third recording device 120 may capture third video data tracking eye movement of the user during an incident.

In various embodiments, the recording devices 105, 115, 120 may each comprise a body (e.g., housing) comprising mechanical features configured to couple recording devices to a respective surface. Recording devices 105, 115, 120 may be configured to couple (e.g., mount) to a user, e.g., to interface with an article of clothing or a mount assembly on a user. In response to being mounted to the user, recording devices 105, 115, 120 may be positioned to capture incident information at a fixed position relative to the user. In some examples, a first recording device 115 may mount to a belt mount as shown in FIG. 1, a chest mount, or a shoulder mount on the user. The first recording device 115 may comprise a torso-mounted camera. In some examples, a second recording device 105 may mount to a shoulder mount, a head mount, or to an accessory (e.g., glasses or hat) on a user. The second recording device may comprise a head-mounted camera. A fixed position of the second recording device 105 may be moveable relative to a fixed position of the first recording device 115. For example, a user may rotate their head, causing the fixed position of the second recording device 105 to move relative to, and independent of, the fixed position of the first recording device 115. In some examples, a third recording device 120 may mount to an accessory (e.g., glasses or hat) on a user. The third recording device 120 may comprise an eye-tracking camera.

At least one recording device of the recording devices 105, 115, 120 may communicate with other entities. For example, the at least one recording device may communicate with computing device 110 of the recording system 100 via network 102. In some embodiments, a first recording device 115 may communicate with other entities of recording system 100 via network 102, and other recording devices 105, 120 may communicate with first recording device 115. In other embodiments, each recording device of the recording devices 105, 115, 120 may separately communicate with other entities of the recording system 100 via network 102.

Network 102 may include a cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

Electronic communications between the systems and devices may be unsecure. A network may be unsecure. In other embodiments, and to provide secure communications, electronic communications disclosed herein may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6,and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

In various embodiments, recording system 100 may comprise a computing device separate from one or more recording devices. The computing device may be configured to process video data captured by the one or more recording devices. For example, recording system 100 comprises computing device 110. Computing device 110 comprises a network interface, communications module, or communications application that includes instructions that cause the computing device to establish a communication link between other computing devices or recording devices via the network 102. In some embodiments, the communication links described herein are peer-to-peer communication links. In other embodiments, the communication links described herein are server-mediated communication links. In other embodiments, the communication links described herein use one or more protocols, such as the internet protocol, mobile telephony protocols, push-to-talk over cellular protocols, and the like.

The computing device 110 may comprise a remote computing device. The remote computing device may comprise a dispatch device or user terminal. Computing device 110 may comprise a laptop computer, desktop computer, mobile phone, or other computing device. In some embodiments, the computing device 110 may comprise a user input device (e.g., a mouse and/or keyboard) and a display enabling a user of the computing device to view and interact with content stored and maintained by the computing device. In some embodiments, computing device 110 may be associated with a user ID.

In various embodiments, computing device 110 may additionally or instead comprise a server or cloud-computing infrastructure configured to host and maintain operation of processing algorithms for generating simulated video data from video data. For example, computing device 110 may comprise an evidence management system. In embodiments, computing device 110 may comprise one or more remote computing devices configured to simulate user perception by performing one or more operations further disclosed herein.

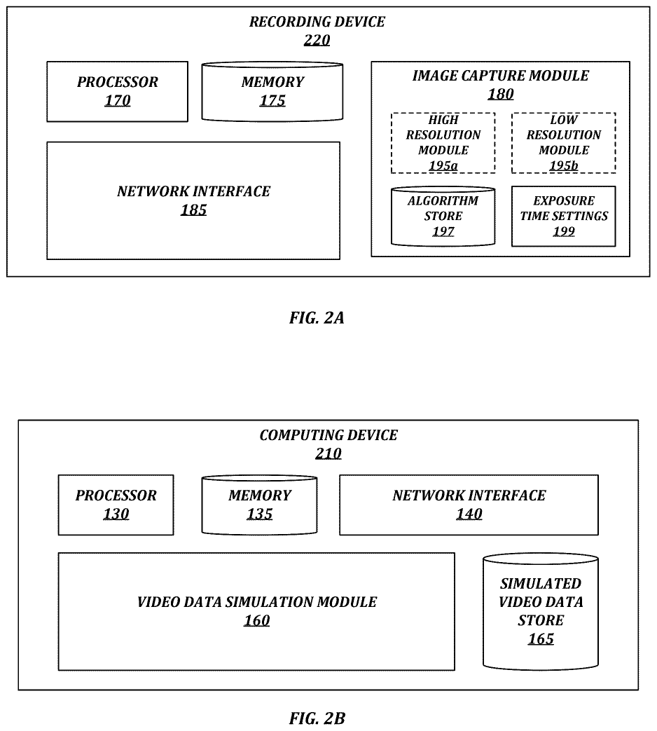

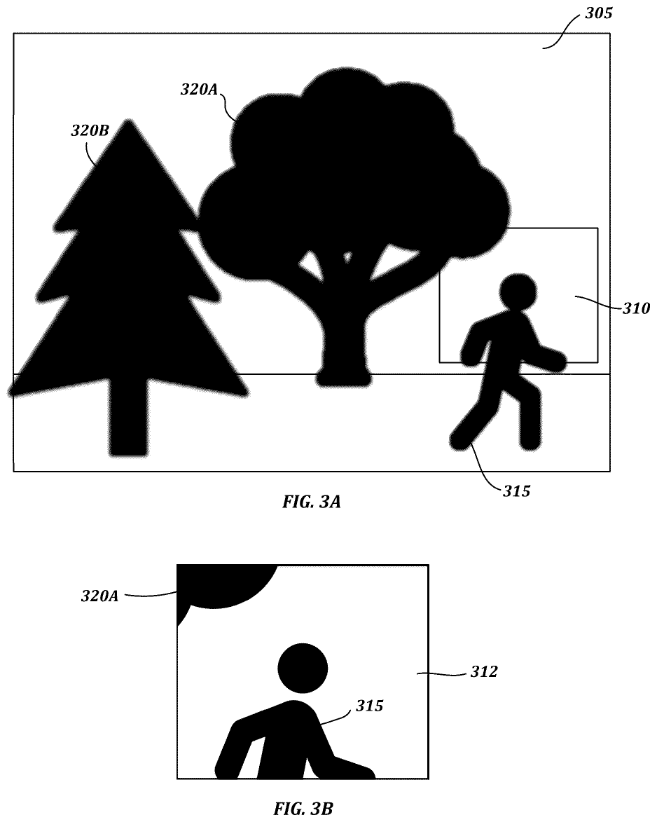

In various embodiments, and with reference to FIG. 2A, an exemplary recording device 220 is disclosed. Recording device 220 may comprise any suitable device configured to capture incident information. Recording device 220 may comprise a camera. For example, recording device 220 may comprise a body-worn camera, an in-vehicle camera, a smart phone, or the like. In various embodiments, recording device 220 comprises a body configured to house (fully and/or at least partially) various mechanical, electrical, and/or electronic components configured to aid in performing the functions of recording device 220. Recording device 220 may perform the function of one of recording devices 105, 115, or 120 with brief reference to FIG. 1.

In the example embodiment of FIG. 2A, recording device 220 comprises processor 170, memory 175, network interface 185, and image capture module 180. Image capture module 180 comprises one or more optional modules and/or stores, such as, for example, high resolution module 195a, low resolution module 195b, algorithm store 197, and exposure time settings 199. In various embodiments, recording device 220 may comprise additional or fewer modules, and processes performed by modules described herein may be in part or in whole performed by other modules or entities of the recording system 100.

In various embodiments, the processor 170 may comprise any circuitry, electrical components, electronic components, software, and/or the like configured to perform various operations and functions discussed herein. For example, the processor 170 may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, the processor 170 may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, the processor 170 may include data buses, output ports, input ports, timers, memory, arithmetic units, and/or the like.

The processor 170 may be configured to provide and/or receive electrical signals whether digital and/or analog in form. The processor 170 may provide and/or receive digital information via a data bus using any protocol. The processor 170 may receive information, manipulate the received information, and provide the manipulated information. The processor 170 may store information and retrieve stored information. Information received, stored, and/or manipulated by the processor may be used to perform a function, control a function, and/or to perform an operation or execute a stored program.

The processor 170 may control the operation and/or function of other circuits and/or components of recording device 220. The processor 170 may receive status information regarding the operation of other components, perform calculations with respect to the status information, and provide commands (e.g., instructions) to one or more other components. The processor 170 may command another component to start operation, continue operation, alter operation, suspend operation, cease operation, or the like. Commands and/or status may be communicated between the processor and other circuits and/or components via any type of bus (e.g., SPI bus) including any type of data/address bus.

In various embodiments, the processor 170 may be in electrical, electronic, and/or mechanical communication with one or more components of recording device 220. For example, the processor may be in communication with the memory 175, the network interface 185, image capture module 180, and/or the like.

In various embodiments, the memory 175 may comprise one or more memory, data structures, or the like configured to store data, programs, and/or instructions. The memory 175 may be in electrical and/or electronic communication with the processor, the network interface, image capture module 180, and/or any other suitable component of the recording device.

In an embodiment, the memory 175 may comprise a tangible, non-transitory computer-readable memory. Instructions stored on the tangible non-transitory memory may allow the processor to perform various operations, functions, and/or steps, as described herein. For example, in response to the processor executing the instructions on the tangible non-transitory memory, the processor 170 may communicate with image capture module 180 to capture image and/or audio data, end capturing of the image and/or audio data, and/or the like, as discussed further herein. As a further example, in response to the processor 170 executing the instructions on the tangible non-transitory memory, the processor may communicate with an auxiliary recording device, via the network interface 185, to capture image and/or audio data, end capturing of the image and/or audio data, and/or the like, as discussed further herein. The processor may execute the instructions in response to operation of recording device 220 by a user, as discussed further herein. In an embodiment, the memory 175 may also be configured to receive, store, and maintain incident recordings, including captured image and audio data. In that regard, the memory may include a storage medium, data structure, database, memory unit, hard-disk drive (HDD), solid state drive (SSD), removable memory, and/or the like.

In various embodiments, the network interface 185 may be configured to enable the transmission and/or reception of data between recording device 220 and one or more additional devices, servers, networks, or the like. For example, the network interface 185 may be configured to enable the transmission and/or reception of data between recording device 220 and an auxiliary recording device of recording system 100 (e.g., between recording device 115 and auxiliary recording device 105 of FIG. 1). The network interface 185 may be in electric and/or electronic communication with the processor 170 and/or the memory 175. The network interface 185 may comprise one or more suitable hardware and/or software components capable of enabling the transmission and/or reception of data, such as, for example, a communications unit, a transmitter, and/or a receiver. In various embodiments, recording device 220 may only have a receiver configured to receive data (e.g., images, video, etc.) from an auxiliary recording device and/or other entities of the recording system 100. In various embodiments, recording device 220 may have a transmitter and a receiver to transmit data (e.g., instructions) to and receive data (e.g., images, video, etc.) from an auxiliary recording device and/or other entities of the recording system 100.

In various embodiments, image capture module 180 may be configured to capture an image or series of images (e.g., video). For example, during an incident recording, image capture module 180 may be configured to capture an image or series of images of the incident recording. Image capture module 180 may comprise various hardware and/or software components configured to capture images and/or video. For example, image capture module 180 may comprise one or more image sensors, one or more optical elements, and/or one or more image processors configured to capture images and/or video. An image sensor of the one or more image sensors may capture narrow angle field of view, a wide-angle field of view, and/or the like.

In various embodiments, one or more optical elements of image capture module 180 may comprise one or more camera lenses (e.g., a multi-lens image capture module). For example, image capture module 180 may comprise a forward capture lens configured to capture images at least partially forward the user, and a rearward capture lens configured to capture images at least partially rearward the user. An image capture module 180 may also comprise one or more side or profile capture lenses configured to capture images peripheral the user. A processor of the camera may coordinate with the plurality of camera lenses to capture images at a same time, or near same time. The one or more optical elements, in combination with one or more image sensors of image capture module 180, may be configured to capture an image having a narrow angle field of view or a wide-angle field of view.

In various embodiments, image capture module 180 may comprise an omnidirectional image capture module. The omnidirectional image capture module may be configured to capture a 360-degree field of view relative to the body of recording device 220. The omnidirectional image capture module may comprise a camera lens having a 360-degree field of view, or a plurality of camera lenses enabling a 360-degree field of view. The omnidirectional image capture module may be configured to output images and/or series of images as monoscopic video or stereoscopic video.

In various embodiments, image capture module 180 may comprise an infrared image capture module. The infrared image capture module may comprise any suitable infrared image capture module, including short wavelength infrared (SWIR), medium wavelength infrared (MWIR), and/or long wavelength infrared (LWIR). The infrared image capture module may be configured to detect infrared energy (heat), convert the detected infrared heat into an electronic signal, and process the electronic signal to produce a thermal image.

Image capture module 180 may be in electric and/or electronic communication with the processor 170 and/or the memory 175. The processor 170 may control (e.g., instruct) image capture module 180 to begin capturing images and to end capturing of the images. The processor may also control (e.g., instruct) image capture module 180 to transmit the captured images to the memory 175 for storage. Image capture module 180 may transmit (e.g., stream) the captured images to the memory 175 as the images are captured or in response to image capture module 180 ending capturing of the images.

In various embodiments, image capture module 180 may comprise one or more hardware and/or software components for capturing images or series of images. In the example embodiment of FIG. 2B, image capture module 180 comprises optional high resolution module 195a, optional low resolution module 195b, algorithm store 197, and exposure time settings 199. In other examples, image capture module 180 may comprise additional, fewer, or different hardware or software components. One or more hardware or software components of image capture module 180 may cause one or more cameras of recording device 220 to capture images having different resolutions, exposure times, stabilization, motion blur, overlays, or other visual effects. One or more hardware or software components of image capture module 180 may additionally or instead cause image capture module to generate metadata in association with captured images or series of images.

Optional high resolution module 195a and optional low resolution module 195b enable one or more cameras of image capture module 180 to capture images or series of images having a high resolution or a low resolution, respectively. For example, high resolution module 195a enables one or more cameras of image capture module 180 to capture images or series of images having greater than a threshold number of pixels per degree, e.g., 60 pixels per degree (implemented as 3840×2160 73 deg diagonal field of view camera). Low resolution module 195 b enables one or more cameras of image capture module 180 to capture images or series of images having less than a threshold number of pixels per degree, e.g., 12 pixels per degree (implemented as 1920×1080 180 deg diagonal field of view camera). In some embodiments, image capture module 180 may comprise both a high resolution module 195a and a low resolution module 195b. Image capture module 180 may select between high resolution module 195a and low resolution module 195b based on, for example, an instruction from processor 170, an input by a user of the recording system 100, or one or more other factors associated with the incident, user, environment, or the like. In other embodiments, image capture module 180 may comprise one or the other of high resolution module 195a and low resolution module 195b. For example, an image capture module 180 of a recording device 220 configured only to capture high resolution images may comprise high resolution module 195a. For example, a head-mounted recording device, such as recording device 105 with brief reference to FIG. 1, may comprise a high resolution module 195a and not low resolution module 195b. In another example, an image capture module 180 of a recording device 220 configured only to capture low resolution images, e.g., a security camera, may comprise low resolution module 195b. For example, and with brief reference to FIG. 1, a torso- or chest-mounted recording device 115 may comprise a low resolution module 195b and not high resolution module 195a.

Algorithm store 197 stores and maintains one or more algorithms for capturing images or series of images. The one or more algorithms may comprise a series of instructions and/or operations executed by circuitry of image capture module 180. In various embodiments, algorithm store 197 comprises one or more algorithms for adapting to changes in brightness conditions during captures of images or series of images. For example, algorithm store 197 comprises an algorithm configured to quickly adapt to changes in brightness conditions during incidents, enabling captured image data to accurately reflect any events that occur during the change in brightness conditions. In another example, algorithm store 197 comprises an algorithm configured to adapt more slowly to changes in brightness conditions during incidents. The latter algorithm may enable captured image data to accurately reflect the way in which a human eye adapts to changes in brightness conditions.

In some examples, algorithm store 197 comprises one or more algorithms for stabilizing image data during video capture. Stabilization may be useful in reviewing video data, enabling viewers to review incidents without movement or motion of a user of the recording system interfering with the video data. In other examples, algorithm store 197 does not comprise any stabilizing algorithms, such that video data more accurately reflects the perspective of a user at the incident in motion. In some embodiments, algorithm store 197 may comprise one, both, or a plurality of algorithms for adapting to changes in brightness conditions or stabilization, or may comprise additional algorithms for one or more other purposes.

Exposure time settings 199 may comprise one or more settings enabling cameras of the image capture module 180 to apply different exposure times to captured images. For example, one or more of high resolution module 195a and low resolution module 195b may retrieve exposure time settings 199. Once retrieved, the exposure time settings 199 may be employed by resolution modules 195a, b and/or imaging module 180 to capture images in accordance with the exposure time settings 199. Exposure time may impact darkness or lightness of images or series of images captured by cameras of the image capture module 180. In some embodiments, exposure time settings 199 may be manually or automatically adjusted, e.g., by processor 170, input by user of recording device 220, or based at least in part on environmental conditions, time of incident, or the like. In some embodiments, exposure time settings may be selected based at least in part on an exposure time more accurately mimicking a perception of a user at an incident, e.g., a less optimal exposure time may be selected for capture of images in a dark area such that a captured image reflects darkness in the environment as would be perceived by a user in the dark area.

As previously noted, in various embodiments, image capture module 180 may comprise additional or other settings, algorithm stores, or hardware and/or software modules for enabling capture of images or series of images by recording device 220. Additional or other settings, algorithms, or hardware and/or software modules may be applied to captured images or series of images during capture of image or series of images (e.g., in real-time) or may be applied as post-processing to captured images or series of images.

In various embodiments, a recording device may not comprise an image capture module. In that regard, in order to capture images of an incident the recording device may communicate with an auxiliary recording device configured to capture images. The auxiliary recording device may comprise an image capture module. In various embodiments, the auxiliary recording device may comprise a body or housing separate from the body or housing of the recording device. The auxiliary recording device may comprise a body or housing detachable from the body or housing of the recording device, or may be in wired or wireless connection with the recording device.

In various embodiments, and with reference to FIG. 2B, an exemplary computing device 210 is disclosed. Computing device 210 may comprise any suitable device configured to receive and process video data. For example, computing device 210 may comprise a laptop computer, desktop computer, mobile phone, or other computing device. Computing device 210 may, in some embodiments, alternately comprise a server and/or datastore. In various embodiments, computing device 210 comprises a body configured to house (fully and/or at least partially) various mechanical, electrical, and/or electronic components configured to aid in performing the functions of computing device 210. In embodiments, computing device 210 may perform functions of computing device 110 with brief reference to FIG. 1.

In the example embodiment of FIG. 2B, computing device 210 comprises processor 130, memory 135, network interface 140, video data simulation module 160, and simulated video data store 165. In various embodiments, computing device 210 may comprise additional or fewer modules, and processes performed by modules described herein may be in part or in whole performed by other modules or entities of the recording system 100.

In various embodiments, the processor 130 may comprise any circuitry, electrical components, electronic components, software, and/or the like configured to perform various operations and functions discussed herein. For example, the processor 130 may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, the processor 130 may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, the processor 130 may include data buses, output ports, input ports, timers, memory, arithmetic units, and/or the like.

The processor 130 may be configured to provide and/or receive electrical signals whether digital and/or analog in form. The processor 130 may provide and/or receive digital information via a data bus using any protocol. The processor 130 may receive information, manipulate the received information, and provide the manipulated information. The processor 130 may store information and retrieve stored information. Information received, stored, and/or manipulated by the processor may be used to perform a function, control a function, and/or to perform an operation or execute a stored program.

The processor 130 may control the operation and/or function of other circuits and/or components of computing device 210. The processor 130 may receive status information regarding the operation of other components, perform calculations with respect to the status information, and provide commands (e.g., instructions) to one or more other components. The processor 130 may command another component to start operation, continue operation, alter operation, suspend operation, cease operation, or the like. Commands and/or status may be communicated between the processor and other circuits and/or components via any type of bus (e.g., SPI bus) including any type of data/address bus.

In various embodiments, the processor 130 may be in electrical, electronic, and/or mechanical communication with one or more components of computing device 210. For example, the processor may be in communication with the memory 135, the network interface 140, video data simulation module 160, and/or the like.

In various embodiments, the memory 135 may comprise one or more memory, data structures, or the like configured to store data, programs, and/or instructions. The memory 135 may be in electrical and/or electronic communication with the processor 130, the network interface 140, video data simulation module 160, and/or any other suitable component of the computing device 210. In an embodiment, the memory 135 may comprise a tangible, non-transitory computer-readable memory. Instructions stored on the tangible non-transitory memory may allow the processor to perform various operations, functions, and/or steps, as described herein. For example, in response to the processor executing the instructions on the tangible non-transitory memory, the processor 130 may communicate with video data simulation module 160 to process video data to generate simulated video data, as discussed further herein. As a further example, in response to the processor executing the instructions on the tangible non-transitory memory, the processor 130 may communicate with simulated video data store 165 to retrieve and/or display simulated video data. The processor may execute the instructions in response to operation of computing device 210 by a user, as discussed further herein.

In various embodiments, the network interface 140 may be configured to enable the transmission and/or reception of data between computing device 210 and one or more additional devices, servers, networks, or the like. For example, the network interface 140 may be configured to enable the transmission and/or reception of data between computing device 210 and a recording device of recording system 100 (e.g., between computing device 110 and recording device 115 of FIG. 1). The network interface 140 may be in electric and/or electronic communication with the processor 130 and/or the memory 135. The network interface 140 may comprise one or more suitable hardware and/or software components capable of enabling the transmission and/or reception of data, such as, for example, a communications unit, a transmitter, and/or a receiver.

The video data simulation module 160 receives video data from one or more recording devices of a user at an incident and combines the received video data to provide simulated video data. Simulated video data indicates or represents perception of the user at the incident. That is, because captured video data may include objects or events not visible to a user at an incident, e.g., due to brightness conditions, lighting adaptation of an eye of the user, head orientation of the user, gaze of the user, or other conditions at the incident, the video data simulation module 160 modifies the received video data to more accurately represent what the user is likely to have perceived at the incident, e.g., what the user is likely to have been able to react to or engage with at the incident. In the simulated video data, the perception of the user may be indicated visually. The perception may be indicated in accordance with differences in visual characteristics between a portion of the simulated video data determined to be perceived by a user and another portion of the same simulated video data not determined to be perceived by the user.

In various embodiments, the video data simulation module 160 receives first video data from a first recording device worn by a user at an incident, e.g., first video data from first recording device 115 of FIG. 1. Video data simulation module 160 also receives second video data from a second recording device worn by the user, e.g., second video data from second recording device 105. In various embodiments, first video data may be at least partially the same as the second video data (e.g., the first video data and the second video data may each capture the same incident information from different points of view). For example, first video data may capture a view of an environment including a group of people from a first point of view and second video data may capture a view of a subset of the environment including a person of the group of people from a second point of view. The first video data may be at least partially different than the second video data (e.g., the first video data may capture incident information that the second video data did not capture, the second video data may capture incident information that the first video data did not capture, etc.). In various embodiments, first video data and second video data may differ in one or more qualities. The one or more qualities may comprise a difference in which video data is captured and/or stored. The one or more qualities may comprise non-content-related properties of the video data. For example, the first video data and second video data may have different resolutions, different exposure times, different shapes, different fields of view, different processing algorithms applied, or the like.

In some embodiments, the video data simulation module 160 may additionally receive third video data from a third recording device, e.g., third video data from third recording device 120 of FIG. 1. Third video data may track movement of an eye of the user at the incident.

In embodiments, video data simulation module 160 matches corresponding portions of first video data and second video data. The corresponding portions may be determined in accordance with information captured in the first video data and second video data. The corresponding portions may comprise corresponding content separately captured in the first video data and the second video data. In some embodiments, the corresponding portions may comprise a subset of the first video data and/or second video data in which a same object is represented. Alternately or additionally, the corresponding portions may comprise a subset of the first video data and/or second video data in which a same portion of an environment is represented. For example, video data simulation module 160 may apply one or more object recognition algorithms to determine an object in first video data corresponding to, e.g., being the same object as, an object in second video data. In another example, video data simulation module 160 may determine relative positions and orientations of first recording device and second recording device to determine portions of first video data that correspond to portions of second video data. In other examples, other methods for determining corresponding portions of first video data and second video data may be used.

In embodiments, video data simulation module 160 combines first video data and second video data to provide simulated video data. The simulated video data may comprise both information captured in the first video data as well as information captured in the second video data. In some embodiments, simulated video data may additionally comprise other information, e.g., overlaid images, text, video data, or the like from one or more other sources. Video data simulation module 160 may combine the first video data and the second video data in various manners. For example, and in various embodiments, video data simulation module 160 overlays second video data within a portion of the first video data. Visual content of the portion of the first video data may match visual content of the second video data. For example, the visual content may correspond to same objects, points of view, people, or the like captured at the incident. In some embodiments, video data simulation module 160 may modify a shape of field of view of the second video data. For example, video data simulation module 160 may modify a rectangular field of view of the second video data to comprise a non-rectangular field of view. The non-rectangular field of view may comprise, for example, a square or circular field of view. Alternately or additionally, video data simulation module 160 may modify a rectangular field of view having a first aspect ratio to have a second aspect ratio different from the first aspect ratio. For example, video data simulation module 160 may modify a rectangular field of view having an aspect ratio of, for example, 4:3 to a rectangular field of view having an aspect ratio of 3:2 Video data simulation module 160 may select a shape for a field of view based at least in part on a shape representative of a perception of the user.

In other embodiments, and after corresponding portions of the first video data and the second video data are matched, a portion of the first video data that corresponds to the second video data may be modified independent of the second video data. The portion of the first video data may be identified using the second video data. For example, a relative location of the first video data within second video data may be used to identify a location of the portion of the first video to which the subsequent modification is applied. The location of the portion of the first video data may be set equal to the relative location. Alternately or additionally, the location of the portion of the first video data may be centered at a same location as a center point of the relative location. However, a subsequent modification may be performed using a one or more predetermined algorithms configured to indicate the perception of the user relative to the portion of the first video data. The one or more predetermined algorithms may be applied without reference to, or involvement otherwise, of the second video data after the corresponding portions of the first video data and the second video data are matched. For example, the portion of the first video data may be brightened and/or sharpened relative to another portion of the first video data that does not align with the perception of the user. Accordingly, video data simulation module 160 may generate simulated data in accordance with combining the first video data and the second video data, and/or modifying a portion of the first video data corresponding to the second video data according to various aspects of the present disclosure.

In various embodiments, video data simulation module 160 may apply one or more smoothing algorithms to the simulated video data. The one or more smoothing algorithms may be applied to provide image fusion between the second video data and the portion of the first video data. The smoothing algorithms may alter a manner in which a characteristic of the first video data transitions to a corresponding characteristic of the second video data. The smoothing algorithms may provide a gradual transition between the characteristic of the first video data and the second video data. The smoothing algorithms may provide a more gradual and/or continuous transition between the first video data and the second video data relative to a transition in the simulated video data before the smoothing algorithms are applied. In examples wherein first video data and second video data have one or more different qualities as previously noted, video data simulation module 160 may apply one or more smoothing algorithms to smooth one or more differences between the portion of the simulated video data corresponding to the first video data and the portion of the simulated video data corresponding to the second video data. An image of the first video data may be smoothly fused together with an image of the second video data in accordance with applying the one or more smoothing algorithms. For example, video data simulation module 160 may smooth a resolution of the simulated video data between a first portion of the simulated video data corresponding to the first video data and a second portion of the simulated video data corresponding to the second video data. In another example, video data simulation module 160 may smooth motion blur, lighting effects or adaptations, stabilization, or the like.

In embodiments, video data simulation module 160 transmits the simulated video data to be stored by computing device 210. In some embodiments, simulated video data is stored in a simulated video data store 165. Simulated video data store 165 may be any data store or data structure, or may be a component of a larger system comprising information about incidents, e.g., a dispatch system. Simulated video data store 165 may store simulated video data in association with other information about the incident, including, for example, timestamps, location data, user identifiers, case numbers, or the like.

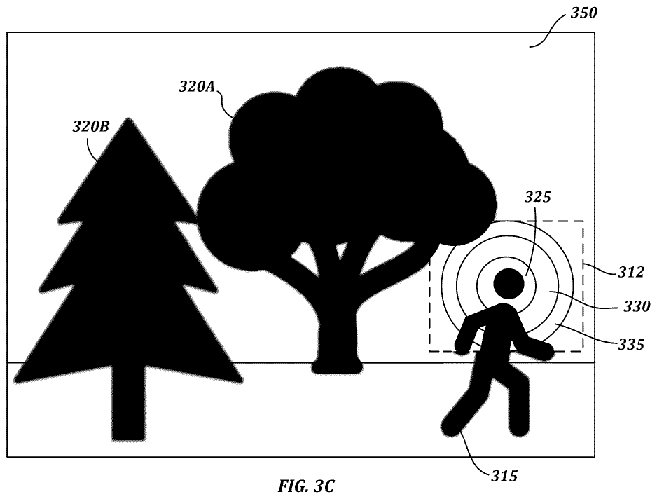

FIGS. 3A-3C are example illustration of video data captured by the one or more cameras and processed to generate simulated video data, according to some embodiments. The video data may be captured by one or more recording devices of system 100 and/or recording device 220 of FIG. 2A. The video data may be processed by one or more recording devices of system 100, recording device 220 of FIG. 2A, and/or computing device 210 of FIG. 2B with brief reference to FIG. 1-2B. FIG. 3A is an example illustration of first video data captured by a first recording device. For example, the first video data may be captured and recorded by first recording device 115 of FIG. 1.

In various embodiments, first video data 305 of an incident may be captured by a first recording device mounted to a user at the incident. For example, the first recording device may comprise a recording device mounted to a belt mount, a chest mount, or a shoulder mount of a user at the incident. The first recording device may comprise a camera. First recording device may comprise one or more settings, algorithms, or processes for capturing and processing the captured first video data 305. For example, first recording device may capture images having a first aspect ratio, a first resolution, a first field of view, and/or a first exposure time. In another example, first recording device may apply a first algorithm to generate first video data 305. First recording device may apply the first algorithm to video data captured by the first recording device to provide the first video data 305. In some examples, first recording device may apply the first algorithm to the first video data 305 to generate additional information. For example, first recording device may use a first algorithm for adapting to changes in brightness conditions, may apply a first stabilization algorithm to generate first video data 305, may apply an object recognition algorithm to the first video data 305, may apply a license plate recognition algorithm to the first video data 305, or the like. In other examples, first recording device may apply other settings, algorithms, or processes to the first video data 305 or to generate the first video data 305.

FIG. 3B is an example illustration of second video data 312 captured by a second recording device. For example, second video data 312 may be captured by a second recording device 105 of FIG. 1. In various embodiments, second video data 312 of an incident may be captured by a recording device mounted to the user at the incident. For example, the second recording device may comprise, e.g., a recording device mounted to a head mount, a glasses mount, or a hat mount of a user at the incident. Second recording device may comprise one or more settings, algorithms, or processes for capturing and processing the second video data 312. One or more of the settings, algorithms, or processes may be different than the settings, algorithms, or processes applied by first recording device to capture first video data 305. For example, second recording device may capture images having a second aspect ratio, a second resolution, a second field of view, and a second exposure time. In some embodiments, second resolution of second video data 312 may be higher than first resolution of first video data 305. In some embodiments, second exposure time of second video data 312 may be shorter than first exposure time of first video data 305. In some embodiments, first video data 305 comprises a wider field of view than second video data 312. In other examples, second recording device may use a second algorithm for adapting to changes in brightness conditions, may apply a different or no stabilization algorithm to generate second video data 312, may apply a different or no object recognition algorithm to the second video data 312, may apply a different or no license plate recognition algorithm to the second video data 312, or the like. In some embodiments, second recording device may apply a second algorithm for changes in brightness conditions that adapts more slowly than a first algorithm for changes in brightness conditions applied by first recording device, wherein the slower algorithm mimics an adaptation to brightness conditions of the human eye. In other examples, second recording device may apply other settings, algorithms, or processes to the second video data 312 or to generate the second video data 312.

In embodiments, first video data and second video data captured by different recording devices may at least partially comprise same information. The same information may comprise one or more objects and/or portions of an environment at an incident separately captured by the different recording devices. In the example of FIG. 3A, first video data 305 comprises one or more objects 320 and a person 315 at the incident. The one or more objects 320 may comprise, for example, a first object 320A and a second object 320B. First object 320A and a second object 320B may be disposed in different locations within first video data 305. In other embodiments and at other incidents, first video data 305 may comprise additional, fewer, or different objects, e.g., vehicles, buildings, or animals, and may comprise additional, fewer, or different humans, e.g., civilians, law enforcement, or the like. In various embodiments, a portion 310 of first video data 305 corresponds to second video data 312, as illustrated in conjunction with FIG. 3B, such that visual content of the portion 310 of first video data 305 corresponds to visual content of the second video data 312. In the example of FIG. 3B, second video data 312 comprises first object 320A and a person 315 at the incident, the one or more objects and person corresponding to objects and person captured in first video data 305. Second video data 312 does not comprise second object 320B, despite second object 320B being captured in first video data 305. In other examples, second video data 312 may additionally or instead comprise one or more objects or people that are not captured in first video data 305.

In embodiments, first video data and second video data may be combined to generate simulated video data. The simulated video data may represent a perspective of a user at an incident. The simulated video data may be different than each of the first video data and the second video data alone. The simulated video data may comprise elements different than elements of the first video data and the second video data alone. FIG. 3C is an example illustration of simulated video data 350 provided by a computing device. The computing device may comprise the computing device 110 of FIG. 1 and/or the computing device 210 of FIG. 2B. The simulated video data 350 may be provided based at least in part on the first video data and the second video data recorded by recording devices of recording system 100. Simulated video data 350 comprises a first portion of video data corresponding to first video data 305 and a second portion of video data corresponding to second video data 312. In various embodiments, simulated video data 350 comprises second video data 312 overlaid within a portion of first video data 305, wherein the visual content of the second video data matches the visual content of the portion of the first video data. In the example simulated video data 350 of FIG. 3C, simulated video data comprises one or more objects 320 and a person 315 captured in first video data 305 and/or second video data 312.

In various embodiments, simulated video data 350 is smoothed or modified to accommodate differences in qualities or settings between first video data 305 and second video data 312. In the example embodiment of FIG. 3C, first video data 305 comprises a first resolution and second video data 312 comprises a second resolution. By applying a smoothing algorithm, simulated video data 350 comprises a resolution gradient between second video data 312 and the portion of first video data 305. In accordance with the resolution gradient, a first portion 325 of simulated video data comprises the second resolution, a second portion 330 comprises a third resolution, a third portion 335 comprises the first resolution. In some embodiments, additional portions with additional intermediate gradients may be provided or, alternatively, a continuous resolution gradient may be imparted to simulated video data 350 within the portion of simulated video data 350 that corresponds to second video data 312. In some embodiments, first portion 325 of simulated video data comprises a highest resolution relative to other portions of the simulated video data 350. The highest resolution may correspond to the resolution of second video data 312 and third portion 335 of simulated video data comprises a lowest resolution relative to other portions of the simulated video data 350. The lowest resolution may correspond to the resolution of the first video data 305. In various embodiments, other smoothing algorithms or processes may be applied to smooth a difference in qualities or settings between portions of simulated video data 350. For example, the other smoothing algorithms or processes may be applied to smooth stabilized and non-stabilized portions of simulated video data, to smooth portions of simulated video data having different adaptations to brightness conditions, or the like.

In various embodiments, simulated video data 350 may comprise one or more other modifications or adjustments to portions of first video data 305 and second video data 312. For example, in some embodiments, simulated video data 350 comprises a cropped portion of second video data 312. The cropped portion of second video data 312 may comprise less than all video data in a field of view of second video data 312 as originally captured. The portion of second video data 312 may be cropped to mimic a field of view of a human eye, to adjust an aspect ratio of the second video data, and/or to modify a shape of the second video data. In another example, in some embodiments, simulated video data 350 may be modified or adjusted to comprise one or more of: overlaid text, e.g., indicating a user identity, a timestamp, a location, or the like; associated metadata; or the like.

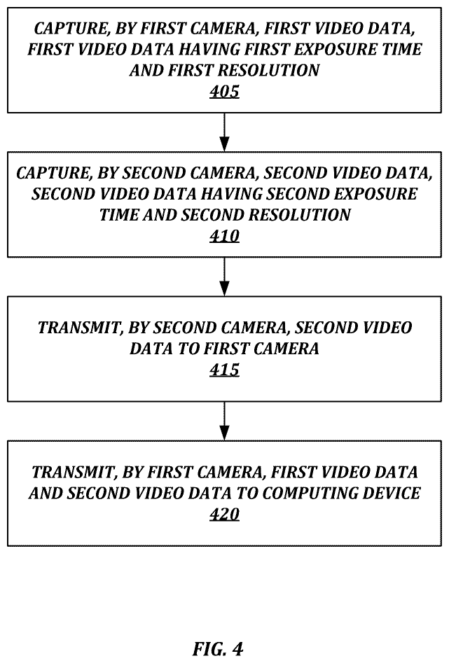

FIG. 4 is a flowchart illustrating a method for capturing video data for generating simulated video data, according to some embodiments. For example, and in accordance with various embodiments, the method may include one or more steps for capturing and transmitting video data by recording devices. In embodiments described in conjunction with FIG. 4, the method may be performed by one or more recording devices similar to any recording devices described herein, e.g., the recording device 220 of FIG. 2A. In other embodiments, the method may be performed in part or in whole by other entities of the recording system 100. In other embodiments, the method may comprise additional or fewer steps, and the steps may be performed in a different order than described in conjunction with FIG. 4.

In embodiments, a first recording device of the recording system captures 405 first video data. The first recording device may be a body camera comprising a mount configured to attach to a user of the recording device. The first recording device may attach to a torso of the user. In some examples, first recording device may mount to a belt mount, a chest mount, or a shoulder mount of a user at an incident. First recording device applies first settings to the captured first video data. The first settings may comprise, for example, a first field of view, a first resolution, and/or a first exposure time. The first recording device may additionally comprise one or more algorithms to capture video data. The one or more algorithms may comprise a first algorithm for adapting to changes in brightness conditions, a first algorithm for adapting to motion or blur, and/or a first algorithm for detecting a focus point. In some embodiments, first recording device may additionally apply one or more processing algorithms to first video data. The one or more processing algorithms may be applied to video data in real-time and/or after video data is captured.

A second recording device of the recording system captures 410 second video data. In various embodiments, second recording device is a body camera comprising a mount configured to attach to a user of the second recording device. The user may comprise a same user to which the first recording device is attached. In various embodiments, second recording device may be connected via a wire to first recording device. In some examples, second recording device may mount to head of a user at an incident. For example, the second recording device may be mounted to the user via a hat mount, a glasses mount, a collar mount, a neck mount, or a shoulder mount. Second recording device applies second settings to the captured second video data.

In various embodiments, first settings of the first recording device may be partially or wholly different from second settings of the second recording device. In some embodiments, the first field of view is wider than the second field of view. The second field of view may be representative of a field of view of a user at an incident. For example, the second field of view may correspond to a normal or standard field of view of a human eye (e.g., a horizontal field of view of approximately 190 degrees), and the first field of view may be greater than a normal or standard field of view of a human eye (e.g., a horizontal field of view greater than 210 degrees).

In some embodiments, the first video data may be captured by the first recording device using one or more different settings than the second video data captured by the second recording device. In some embodiments, the second video data comprises a different (e.g., higher) resolution than the first video data. In some embodiments, the second video data comprises a shorter exposure time than the first video data. In some embodiments, the second recording device comprises a slower algorithm for adapting to brightness conditions than the first recording device, such that the second video data captures changes in brightness conditions at a slower rate than the first video data, wherein the slower rate is representative of the rate at which a human eye adapts to changes in brightness conditions. In some embodiments, the first recording device applies one or more stabilizing algorithms to the first video data and the second recording device does not apply stabilizing algorithms to the second video data, such that the second video data captures effects of movement by the user at the incident on perception at the incident.

In various embodiments, the second recording device transmits 415 second video data to the first recording device. The second recording device may transmit second video data via a wired or wireless communications channel with first recording device, as described in conjunction with exemplary recording device 220 of FIG. 2A. The first recording device transmits 420 the first video data and the second video data to a computing device of the recording system 100, the computing device configured to generate simulated video data representative of the perception of the user of the first and second recording devices at the incident.

In some embodiments, a third recording device configured to capture third video data having third settings may also transmit third video data to the first recording device, and the first recording device additionally transmits the third video data to the computing device. For example, the third recording device is worn by the user at the incident, e.g., mounted to a glasses mount of the user, and is configured to track movement of an eye of the user at the incident. In another example, the third recording device may be mounted in a fixed position during the incident, e.g., a vehicle mount or security camera, and may be configured to capture a third perspective of the incident.

In various embodiments, each of the first video data and the second video data may be transmitted separately to another device for subsequent processing. For example, the second recording device may transmit second video data to computing device of the computing system and first recording device may transmit first video data to computing device of the recording system. In various embodiments, the second recording device may transmit second video data to an intermediate device of the recording system and first recording device may transmit first video data to the intermediate device of the recording system. The intermediate device may then transmit first and second video data to the computing device of the recording system. The intermediate device may be, for example, a vehicle-mounted device, a mobile device or mobile computer, a smart hub of the first and second recording devices, or the like.

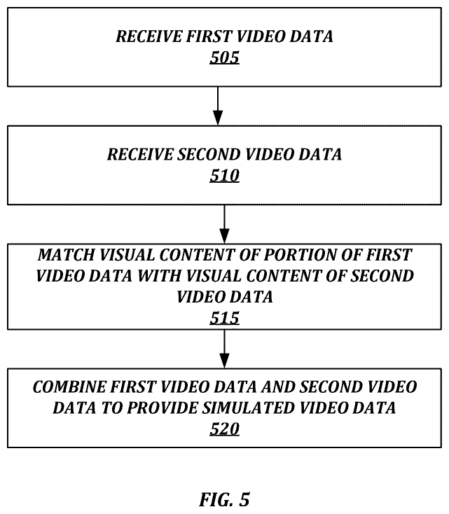

FIG. 5 is a flowchart illustrating a method for processing video data to generate simulated video data, according to some embodiments. For example, and in accordance with various embodiments, the method may include one or more steps for receiving and determining visual content of video data representative of perception of a user to generate simulated video data. In embodiments described in conjunction with FIG. 5, the method may be performed by a computing device similar to any computing device described herein, e.g., the computing device 210 of FIG. 2B. In other embodiments, the method may be performed in part or in whole by other entities of the recording system 100. In other embodiments, the method may comprise additional or fewer steps, and the steps may be performed in a different order than described in conjunction with FIG. 5.

In embodiments, a computing device receives 505, 510 first video data and second video data via a communication channel. In some embodiments, the computing device receives 505 the first video data from a first recording device and receives 510 the second video data from a second recording device. In other embodiments, the computing device receives 505, 510 the first video data and the second video data from a first recording device, e.g., a primary recording device of a recording system 100. In some embodiments, the computing device may receive additional data or metadata. For example, the computing device may receive third video data captured by a third recording device. In another example, the computing device may receive metadata (e.g., one or more of timestamps, location data, or the like) associated with one or more of the first video data, the second video data, or the third video data. In another example, the computing device may receive data describing one or more of a user of the recording system, an incident associated with the received video data, or the like.

As described in conjunction with the flowchart of FIG. 4, the first video data may be captured by a first recording device and may comprise first visual content, and the second video data may be captured by a second recording device and may comprise second visual content. The second video data may represent a perception of the user at the incident. For example, the second video data may have a field of view corresponding to a normal or standard field of view of a human eye, a higher resolution or shorter exposure time, and/or may be processed such that changes in brightness conditions at the incident are displayed according to adaptation to the brightness conditions experienced by a human eye. In comparison, first video data may represent a wider field of view, may have lower resolution or higher exposure time, may be stabilized, and/or may be captured by a first recording device having a faster algorithm for adapting to brightness conditions. First video data may provide a more objective view of an incident, e.g., capturing additional information about the incident that second video data may not show, while second video data may provide a view of the incident as perceived by a user at the incident. That is, second video data may reflect one or more of a head orientation of the user, a gaze of the user, or a lighting adaptation of an eye of the user, while first video data captures a fixed perspective of the incident.

In various embodiments, computing device additionally receives third video data via a communication channel. In some embodiments, computing device receives third video data from a first recording device, e.g., primary recording device. In other embodiments, computing device receives third video data from a third recording device of the recording system. Third video data may comprise a third perspective of an incident. For example, third video data may track eye movement of a user of the recording system at the incident. Third video data may additionally be associated with metadata.

The computing device matches 515 visual content of a portion of the first video data with visual content of the second video data. In some embodiments, computing device applies one or more algorithms or machine learning models for object identification in the first video data and the second video data. Based on outputs of the one or more algorithms or machine learning models, computing device identifies visual content of a portion of the first video data corresponding to visual content of the second video data. The visual content may correspond with regard to a physical location and/or object captured in each of the first video data and the second video data at a location of an incident. In some examples, the one or more algorithms or machine learning models may comprise multi-frame methods such as post-processing, 3D convolutions, recurrent neural networks, multi-frame aggregation, sparse propagation, or the like. In other examples, other algorithms or machine learning models may be applied to the first video data and the second video data.

In some embodiments, the computing device matches visual content of a portion of the first video data with visual content of the second video data based at least in part on third video data tracking eye movement of the user. For example, because tracked eye movement of the user may not correspond to head movement of the user captured by the second video data, the computing device may select a subset of the visual content of the second video data as being a center of focus or field of view of the user based on tracked eye movement of the user. The third video data may provide a direction of observation for the eye of the user. A position sensor in each of the first recording device and second recording device may provide a direction of capture for each of the first video data and the second video data. The direction of observation may be further aligned with the direction of capture for each of the first video data and the second video data to match the visual content of the portion of the first video data with the visual content of the second video data. In other embodiments, the computing device matches visual content of a portion of the first video data with visual content of the second video data based at least in part on metadata associated with each of the first video data and the second video data, e.g., metadata identifying relative positions of first recording device during capture of the first video data and of second recording device during capture of second video data. For example, the metadata may include a position and direction of capture for each of the first video data and the second video data. Matching the visual content using the metadata may comprise aligning the visual content in three-dimensional space in accordance with the position and the direction of capture for each of the first video data and the second video data. In other embodiments, the computing device matches visual content of a portion of the first video data with visual content of the second video data based on other factors.

In embodiments, the computing device combines 520 first video data and second video data to provide simulated video data. In various embodiments, the computing device overlays the second video data within a corresponding portion of the first video data based at least in part on the visual content of the portion of the first video data matching with the visual content of the second video data as shown in conjunction with FIG. 3B. Combining 520 the first video data and the second video data may comprise overlaying full, narrow field of view content of the second video data on top of wider field of view content of the first video data. The computing device may apply one or more processing algorithms to the simulated video data. For example, in some embodiments, the computing device applies a smoothing process to smooth a resolution of the simulated video data between a first portion of the simulated video data corresponding to the first video data and a second portion of the simulated video data corresponding to the second video data.

In another example, in some embodiments, combining 520 may comprise applying one or more processes to perform one or more of: smoothing brightness conditions of the first portion of the simulated video data corresponding to the first video data and a second portion of the simulated video data corresponding to the second video data; adjusting stabilized portions of the simulated video data relative to portions of the simulated video data without stabilization; adding text, markers, labels, or other indica to the simulated video data to indicate the second portion of the simulated video data corresponding to the second video data, to include information describing the incident (e.g., timestamps, location information, identification information), and/or the like.

In various embodiments, combining 520 may comprise storing the simulated video data in association with the incident, or may transmit the simulated video data to one or more devices or systems. The simulated video data may be stored by the computing device. The simulated video may be stored, for example, in simulated video data store 165 with brief reference to FIG. 2A.

In various embodiments, a computer-based system may be appropriate for use in accordance with various recording device embodiments of the present disclosure. The accompanying description of a computer-based system may be applicable to servers, personal computers, mobile phones, smart phones, tablet computers, embedded computing devices, and other currently available or yet-to-be-developed devices that may be used in accordance with embodiments of the present disclosure.

A computer-based system may include a processor and a system memory connected by a communication bus. Depending on the exact configuration and type of computer-based system, system memory may be volatile or nonvolatile memory, such as read only memory (“ROM”), random access memory (“RAM”), EEPROM, flash memory, or other memory technology. Those of ordinary skill in the art and others will recognize that system memory typically stores data and/or program modules that are immediately accessible to and/or currently being operated on by the processor. In this regard, the processor may serve as a computational center of the computer-based system by supporting the execution of instructions. The processor may comprise one or more processing units, as discussed further herein. The system memory may comprise one or more memory units, as discussed further herein.

A computer-based system may include a network interface comprising one or more components for communicating with other devices and systems over a network. Embodiments of the present disclosure may access basic services that utilize the network interface to perform communications using common network protocols. The network interface may comprise a communications unit, as discussed further herein.

A computer-based system may also include a storage medium. However, services may be accessed using a computer-based system that does not include means for persisting data to a local storage medium. Therefore, the storage medium may be optional. The storage medium may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like. A storage medium may include one or more memory units, as discussed further herein.

As used herein, the term “computer-readable medium” includes volatile and nonvolatile and removable and nonremovable media implemented in any method or technology capable of storing information, such as computer-readable instructions, data structures, program modules, or other data.

A computer-based system may include input devices, such as a keyboard, keypad, mouse, trackball, microphone, video camera, touchpad, touchscreen, electronic pen, stylus, and/or any other input device described herein. Such input devices may be coupled to the computer-based system by wired or wireless connections including RF, infrared, serial, parallel, BLUETOOTH®, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to a computer-based system (e.g., a client device), or can be integral components of a computer-based system. In some embodiments, multiple input devices may be combined into a single, multifunction input device (e.g., a video camera with an integrated microphone).

A computer-based system may also include output devices such as a display, speakers, printer, and/or any other output device described herein. The output devices may include video output devices such as a display or touchscreen. The output devices also may include audio output devices such as external speakers or earphones. The output devices can be separate from and communicatively coupled to the computer-based system, or can be integral components of the computer-based system. Input functionality and output functionality may be integrated into the same input/output device (e.g., a touchscreen). Any suitable input device, output device, or combined input/output device either currently known or developed in the future may be used with described systems.

In various embodiments, a “processing unit” as described herein may comprise any suitable hardware and/or software-based processing component. For example, a processing unit may comprise one or more of a processing circuit, a processor, an application specific integrated circuit (ASIC), a controller, a microcontroller, a microprocessor, a programmable logic device, logic circuitry, and/or the like.

In various embodiments, a “communications unit” as described herein may comprise any suitable hardware and/or software components capable of enabling the transmission and/or reception of data. A communications unit may enable electronic communications between devices and systems. A communications unit may enable communications over a network. Examples of a communications unit may include a modem, a network interface card (such as an Ethernet card), a communications port, etc. Data may be transferred via a communications unit in the form of signals which may be electronic, electromagnetic, optical, or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 802.11a/b/g/n/ac signal (e.g., Wi-Fi), a wireless communications protocol using short wavelength UHF radio waves and defined at least in part by IEEE 802.15.1 (e.g., the BLUETOOTH® protocol maintained by Bluetooth Special Interest Group), a wireless communications protocol defined at least in part by IEEE 802.15.4 (e.g., the ZigBee® protocol maintained by the ZigBee alliance), a cellular protocol, an infrared protocol, an optical protocol, or any other protocol capable of transmitting information via a wired or wireless connection.

Two or more of the system components may be in electronic communication via a network. As used herein, the term “network” may further include any cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

In various embodiments, a “memory unit” as discussed herein may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

Any database discussed herein, unless specified otherwise, may include relational, hierarchical, graphical, distributed ledger, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Moreover, a database may be organized in any suitable manner, for example, as data tables or lookup tables. Each record stored in a database may be a single file, a series of files, a linked series of data fields, and/or any other data structure or schema.

Any database, system, device, server, or other components of the system described herein may consist of any combination thereof at a single location or at multiple locations. For example, any database described herein may comprise a single database or a plurality of databases (virtual partitions or physically distinct). Each database or system may include any of various suitable security features, such as firewalls, access codes, encryption, decryption, compression, decompression, and/or the like.

In various embodiments, an “input device” as discussed herein may comprise hardware and/or software used to provide data, inputs, control signals, and the like to a computer-based system, software application, etc. For example, an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device.

In various embodiments, an “output device” as discussed herein may comprise hardware and/or software configured to convert information into a human-accessible form, for display, projection, or physical reproduction. For example, an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a printer (e.g., dot matrix printer, inkjet printer, laser printer, 3D printer, wide-format printer, etc.), a braille reader, a composite device (e.g., a device having a plurality of different forms of output), and/or any other output device.

The foregoing description discusses preferred embodiments of the present invention, which may be changed or modified without departing from the scope of the present invention as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments of the invention have been described, the scope of the invention is intended to be measured by the claims as set forth below. In the claims, the term “provided” is used to definitively identify an object that not a claimed element of the invention but an object that performs the function of a workpiece that cooperates with the claimed invention. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”. A person of ordinary skill in the art will appreciate that this disclosure includes any practical combination of the structures and methods disclosed. While for the sake of clarity of description several specifics embodiments of the invention have been described, the scope of the invention is intended to be measured by the claims as set forth below. Where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The words “herein”, “hereunder”, “above”, “below”, and other word that refer to a location, whether specific or general, in the specification shall refer to any location in the specification.

What is claimed is:

1. A method of simulating perception of a user at an incident, comprising:
receiving first video data from a first camera worn by the user at the incident;
receiving second video data from a second camera worn by the user at the incident; and
combining the first video data and the second video data to provide simulated video data, wherein the simulated video data indicates the perception of the user at the incident.

2. The method of claim 1, wherein the second video data comprises a higher resolution than the first video data.

3. The method of claim 1, wherein the simulated video data comprises the second video data overlaid within a portion of the first video data.

4. The method of claim 1, wherein combining the first video data and the second video data comprises smoothing a resolution of the simulated video data between a first portion of the simulated video data corresponding to the first video data and a second portion of the simulated video data corresponding to the second video data.

5. The method of claim 1, wherein the first camera captures a first field of view and the second camera captures a second field of view, and wherein the first field of view is wider than the second field of view.

6. The method of claim 1, wherein the perception of the user comprises at least one of a head orientation of the user, a gaze of the user, or a lighting adaptation of an eye of the user.

7. The method of claim 1, wherein combining the first video data and the second video data comprises matching visual content of a portion of the first video data with visual content of the second video data.

8. The method of claim 1, wherein combining the first video data and the second video data comprises modifying a shape of a field of view captured in the second video data to provide the simulated video data.

9. The method of claim 1, wherein the second video data comprises a shorter exposure time than the first video data.

10. The method of claim 1, wherein the second camera comprises a slower algorithm for adapting to brightness conditions at the incident than the first camera.

11. The method of claim 1, wherein the first video data is video stabilized and the second video data is not video stabilized.

12. The method of claim 1, further comprising:
receiving third video data from a third camera worn by the user at the incident, the third video data tracking movement of an eye of the user at the incident; and
modifying the simulated video data based at least in part on the third video data.

13. A system for simulating perception of a user at an incident, comprising:
a first camera, the first camera worn by the user at the incident and configured to capture first video data;
a second camera, the second camera worn by the user at the incident and configured to capture second video data;
a non-transitory computer-readable medium storing computer-readable instructions for providing simulated video data, the simulated video data indicating perception of the user at the incident; and
a processor communicatively coupled to the first camera, the second camera, and the computer-readable medium, the processor further configured to execute the instructions, wherein the instructions, when executed, cause the processor to perform operations comprising:
receiving first video data from the first camera;
receiving second video data from the second camera; and
combining the first video data and the second video data to provide the simulated video data.

14. The system of claim 13, wherein the second video data comprises a higher resolution than the first video data.

15. The system of claim 13, wherein the simulated video data comprises the second video data overlaid within a portion of the first video data.

16. The system of claim 13, wherein combining the first video data and the second video data comprises smoothing a resolution of the simulated video data between a first portion of the simulated video data corresponding to the first video data and a second portion of the simulated video data corresponding to the second video data.

17. The system of claim 13, wherein the first camera captures a first field of view and the second camera captures a second field of view, and wherein the first field of view is wider than the second field of view.

18. The system of claim 13, wherein the perception of the user comprises at least one of a head orientation of the user, a gaze of the user, or a lighting adaptation of an eye of the user.

19. The system of claim 13, wherein the first camera comprises a torso-mounted camera and the second camera comprises a head-mounted camera.

20. The system of claim 13, further comprising a third camera, the third camera worn by the user at the incident and configured to capture third video data, the third video data tracking movement of an eye of the user at the incident.
